(19) United States
(12) Patent Application Publication
(10) Pub. No.: US 2015/0114976 A1
(43) Pub. Date: Apr. 30, 2015

(54) Concrete CNG Tank and Method of Construction

(71) Applicant: R. Keith Barker, Wahalia, SC (US)

(72) Inventor: R. Keith Barker, Wahalia, SC (US)

(21) Appl. No.: 14/523,426

(22) Filed: Oct. 24, 2014

Related U.S. Application Data
(60) Provisional application No. 61/961,892, filed on Oct. 25, 2013.

(51) Int. Cl. F17C 1/08; F17C 1/16; B29C 67/24

(52) U.S. Cl. CPC F17C 1/08; B29C 67/243; F17C 1/16; B29L 2031/7126
USPC 220/592; 264/516

(57) ABSTRACT

A polymer blend concrete CNG tank comprising a liner member composed of a high density polymer, the tank being preferably disposed within a concrete vault.

This application claims the benefit of U.S. Provisional Patent Application Ser. No. 61/961,892, filed Oct. 25, 2013, the disclosure of which is incorporated herein by reference.

### BACKGROUND OF THE INVENTION

The invention relates in general to storage tanks and their methods of construction, and more particularly relates to storage tanks formed of concrete and used to store and dispense compressed natural gas (CNG).

Concrete tanks for storage of non-pressurized natural gas are known, being either concrete tanks for storing liquid natural gas or concrete structures that house typical non-concrete CNG tanks. The known concrete tanks suffer from permeability and shearing problems.

It is an object of this invention to provide an improved concrete CNG tank capable of storing natural gas under pressure that addresses the problems of permeability and shearing associated with known concrete tanks.

### SUMMARY OF THE INVENTION

The invention in various embodiments is an improved concrete tank suitable for storage of CNG. The tank is formed of a polymer concrete material and is provided with a gas impermeable liner member. CNG filling and dispensing ports are cast into the tank during construction. The tank is preferably disposed in a concrete vault that acts as a secondary containment system, the vault preferably being mostly or completely disposed below the ground surface. Venting ports are provided in the vault for discharge into the atmosphere if any leakage occurs.

In alternate format, the invention can be summarized as a polymer concrete CNG tank comprising a polymer concrete body having reinforcement members embedded therein, a gas and liquid impermeable liner disposed within said polymer concrete body, said liner composed of a material suitable to retain CNG therein, and fill and discharge port members extending through said polymer concrete body and said liner suitable for introduction and removal of CNG from inside said tank; wherein said liner is composed of a high density polymer; wherein said reinforcement members are chosen from the group of reinforcement members consisting of pre-stressed cables, rebar and fibers; said tank being disposed within a concrete vault whereby said concrete vault captures any leakage from said tank; said concrete vault comprising venting port members whereby CNG leakage is vented to atmosphere; and/or comprising a tank form disposed between said polymer concrete body and said liner.

Likewise, the invention can be summarized as a method of forming a polymer concrete CNG tank comprising the steps of forming an inflatable liner composed of high density polymer impermeable to CNG; inflating said liner; positioning reinforcement members about said liner; positioning fill and discharge port members in communication with the interior of said liner; pouring polymer concrete about said liner and allowing said polymer concrete to cure and possibly providing a tank form; and positioning said liner within said tank form prior to said step of inflating said liner.

### BRIEF DESCRIPTION OF THE DRAWINGS

FIG. 1 longitudinal cross-sectional view of an embodiment of the invention.

FIG. 2 is a transverse cross-sectional view of the embodiment of FIG. 1, taken along line A-A.

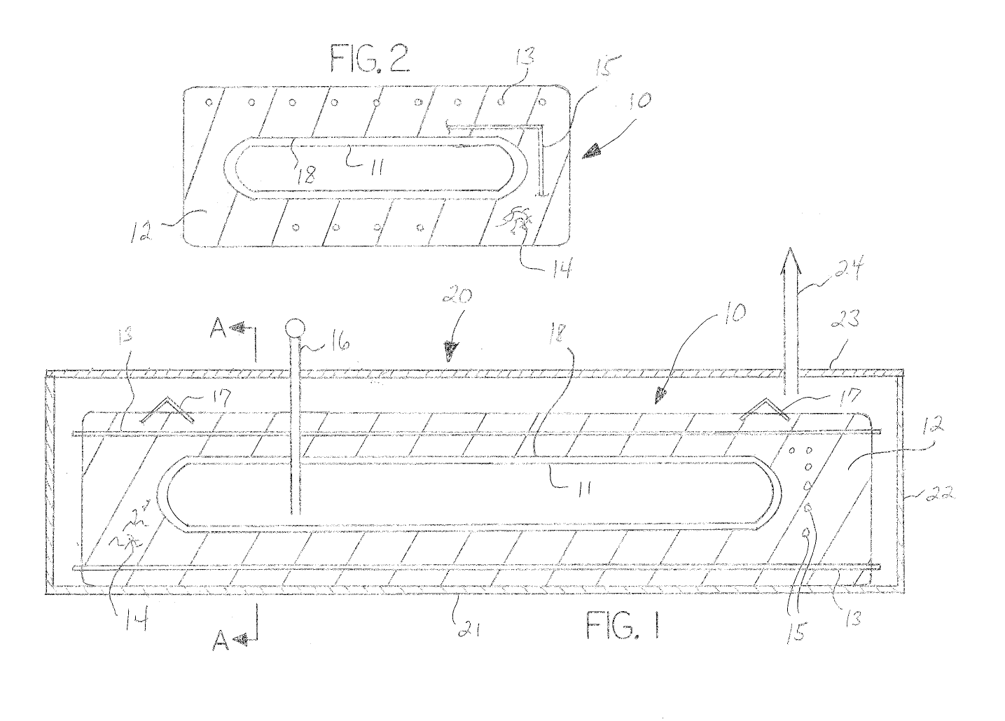

### DETAILED DESCRIPTION OF THE INVENTION

With reference to the drawings, embodiments of the invention will now be described in detail, the descriptions and figures not intended to be limiting. In a broad sense, the invention is a polymer blend concrete CNG tank 10 comprising a liner member 11, the tank 10 being preferably disposed within a concrete vault 20.

Polymer concrete or polymer blend concrete utilizing a resin binder is a known construction material that is advantageous in circumstances requiring high strength and slightly reduced rigidity, such that the cured product has a small degree of flexibility and elasticity in order to resist shearing and cracking. In one possible embodiment, the tank 10 is formed as a polymer concrete body 12 surrounding a large internal void creating by pouring the polymer concrete around an elliptical tank form 18. The tank form 18 may be composed of metal, plastic or similar materials. The tank form 18 is composed of a liquid and gas impermeable material, and must be of sufficient rigidity to remain undistorted during the polymer concrete pouring operation.

In a preferred embodiment, an internal polymer liner 11 is disposed within the polymer concrete body 12, the liner 11 being impermeable to gas and liquid under high pressure. A high density polymer liner sold under the brand AGRU LINER is suitable in this application. The liner 11 may be formed by folding the material and crimping the edges to form an envelope, which is then expanded to be used as the interior mold about which the polymer concrete is poured to form the polymer concrete body 12. Alternatively, the liner 11 may be disposed adjacent the tank form 18.

The polymer concrete body 10 is provided internally with various reinforcing members. Preferably, the tank 10 is provided with pre-stressed cable reinforcement members 13, rebar reinforcement members 15 arranged in a cage-like configuration, and/or fiber reinforcement members 14. Lifting eye members 17 are also provided on the exterior of the tank 10 to enable lifting and transport of the tank 10.

Fill and discharge port members 16 consisting of piping, valves and the like that provide the necessary conduits to the interior of the tank 10 are properly positioned prior to pouring the polymer concrete to preclude the need to breach the polymer concrete body 12 after it has cured. The fill and discharge ports 16 provide access to the interior of the tank form 18 and the liner 11 when present.

A tank 10 constructed as described is capable of withstanding pressures greater than 5000 psi, thereby making the tank 10 suitable for the storage of large quantities of CNG. The tank 10 is relatively inexpensive to construct, can be formed in various shapes and sizes, is easily lifted and transported, and maintains the CNG at reduced temperature even in high temperature environments due to its highly insulative nature.

In a preferred assembly, the tank 10 is located within a preformed concrete vault 20 having a bottom 21, walls 22 and a removable cover 23, which may be formed in a modular assembly. The vault 20 is preferably partially or totally positioned below ground level, and acts as a secondary containment system in the event of there is leakage from the tank 10. Venting port members or conduits 24 may be provided in the vault 20 to allow escaped gas to vent to atmosphere. The presence of the vault 20 increases the insulative properties of the system.

I claim:

1. A polymer concrete CNG tank comprising a polymer concrete body having reinforcement members embedded therein, a gas and liquid impermeable liner disposed within said polymer concrete body, said liner composed of a material suitable to retain CNG therein, and fill and discharge port members extending through said polymer concrete body and said liner suitable for introduction and removal of CNG from inside said tank.

2. The tank of claim 1, wherein said liner is composed of a high density polymer.

3. The tank of claim 1, wherein said reinforcement members are chosen from the group of reinforcement members consisting of pre-stressed cables, rebar and fibers.

4. The tank of claim 1, wherein said reinforcement members are chosen from the group of reinforcement members consisting of pre-stressed cables, rebar and fibers.

5. The tank of claim 1, said tank being disposed within a concrete vault whereby said concrete vault captures any leakage from said tank.

6. The tank of claim 5, said concrete vault comprising venting port members whereby CNG leakage is vented to atmosphere.

7. The tank of claim 1, further comprising a tank form disposed between said polymer concrete body and said liner.

8. A method of forming a polymer concrete CNG tank comprising the steps of:
forming an inflatable liner composed of high density polymer impermeable to CNG;
inflating said liner;
positioning reinforcement members about said liner;
positioning fill and discharge port members in communication with the interior of said liner;
pouring polymer concrete about said liner and allowing said polymer concrete to cure.

9. The method of claim 8, further comprising the step of:
providing a tank form;
positioning said liner within said tank form prior to said step of inflating said liner.
